(19) United States
(12) Patent Application Publication
(10) Pub. No.: US 2006/0170128 A1
(43) Pub. Date: Aug. 3, 2006

(54) Animal feed in pellet form, process and apparatus for preparing same

(75) Inventors: Guy Belanger, St-Jean-Chrysostome (CA); Marcelin Pelletier, St-Nicolas (CA)

Correspondence Address: CROWELL & MORING LLP;INTELLECTUAL PROPERTY GROUP, P.O. BOX 14300, WASHINGTON, DC, 20044-4300, US

(73) Assignee: ALIMENTS BRETON, ST-BERNARD (CA)

(21) Appl. No.: 11/325,510

(22) Filed: Jan. 5, 2006

Related U.S. Application Data
(63) Continuation-in-part of application No. 10/245,726, filed on Sep. 18, 2002, now abandoned.

(51) Int. Cl. B29C 67/00; B29B 9/06

(52) U.S. Cl. 264/117; 264/118; 425/8

(57) ABSTRACT

An animal feed production process and apparatus, and pellet product thereby obtained. The process comprises providing a powder composition into a drum, the drum having a disc, a circumferential wall integral with the disc, and an axis of rotation normal to the disc and inclined relative to a vertical axis, the drum being rotatable about said inclined axis and adapted to pass through an upper and lower zones relative to the disc, the powder composition consisting of fine powders of magnesium oxyde, mono-dicalcium phosphate, and at least one substantially insoluble feed ingredient; whereby when the disc is rotated some of the powder composition is carried towards the upper zone, and some of the powder composition tumbles towards the lower zone by gravity; and then spraying water onto the powder composition as the drum is rotated so as to cause the powder composition to agglomerate into pellets of animal feed.

### TECHNICAL FIELD

The present improvements relate to a feed in pellet form for animals, particularly livestock, and processes for preparing it. More specifically, the improvements relate to animal feed produced by agglomeration of ingredients in powder form.

### BACKGROUND

It is well know that in order to produce and maintain healthy animals, such as cattle, they must be fed with balanced foods such as cereals, and certain additives or supplements such as minerals, vitamins, medicaments, and the like. Food supplements are typically provided in the form of powders, a form which is easily produced industrially. However, animals are not very attracted to powders, even if mixed in with other foods, and have been known to refuse food supplements provided in this form. Therefore, it has been known for decades to provide animal feed in the form of pellets which include some food materials and some food supplements mixed together. However, the existing methods and processes for producing such feeds, as well as the feeds themselves, experience several drawbacks.

Some existing processes make use of binders to join the feed materials together. One drawback of using binders is their additional costs, and the fact that not every binder is good for animals to ingest. Some processes make use of high temperatures to bind the feed materials together. A drawback of this is that high temperatures tend to destroy at least some of the quality nutrients like vitamins. In other known processes, the nutrients are mixed with other materials to provide adherence of the materials into pellets, and/or to render the products adapted to use with their machines. Typically, these processes result in pellets which have a low concentration of nutrients and therefore occupy a relatively high volume, which renders them somewhat cumbersome to handle. In other processes, pellets of a predetermined size are obtained by separating an agglomerated chunk into pellets by means of a die. In these processes, the size of the feed is preset by the die, and is therefore adjustable only by using a die having a different dimension. In still other processes, pellets are submitted to compression during production, which is believed to have drawbacks as well.

In view of the above, it is seen that there remains a need in the art for improved animal feeds, and for processes of making animal feed as well. Among several other needs, there is a need for an improved animal feeds which provides the following characteristics: include some desired food supplements, are well accepted and/or digested by the animals, are nutritive for the animals, are available at relatively low cost and are relatively easy to handle.

### SUMMARY

It is an aim of the improvements to provide a feed for animals, particularly livestock, that is substantially free from dust, relatively cheap to produce, and which is well accepted by the animals.

It is another aim of the improvements to provide a manufacturing process that lends itself to produce animal feed including a choice of ingredients selectable by the customer.

It is another aim of the invention to produce a high-yield feed which has a relatively high concentration of nutritive ingredients, and which therefore occupies less volume and is easier to handle, for the animal to receive the benefits of a full ration of nutrients while eating a lesser quantity.

It is another aim of the improvements to produce a feed which provides a high level of absorption of nutritive ingredients upon digestion by the animal. In one aspect, the feed is not compressed during processing and is therefore porous and easily digestible by enzymes in the stomach of the animal.

It is a another aim of the improvements to provide a process and apparatus which can produce animal feed of easily adjustable dimensions.

In accordance with an aspect of the invention, the improvements provide a process for pelletizing animal feed. The process comprises: providing a powder composition into a drum, the drum having a disc, a circumferential wall integral with the disc, and an axis of rotation normal to the disc and inclined relative to a vertical axis, the drum being rotatable about said inclined axis and defining an upper and lower zones through which the disc passes during rotation, the powder composition consisting of powders of a food-grade hydraulic binder, a food-grade phosphate salt, and at least one substantially insoluble feed ingredient; whereby when the disc is rotated some of the powder composition is carried towards the upper zone, and some of the powder composition tumbles towards the lower zone by gravity; and then spraying water onto the powder composition as the drum is rotated so as to cause the powder composition to agglomerate into pellets of animal feed.

In accordance with another aspect of the invention, the improvements provide an apparatus for producing animal feed in pellet form by agglomeration from a powder composition in the presence of water; the apparatus comprising: a drum, the drum having a disc and a wall circumferential to the disc, the drum being rotatable around a rotation axis thereof, the rotation axis being normal to the disc and being inclined with respect to a vertical axis, defining an upper zone and a lower zone through which the disc passes during rotation; at least one spray nozzle adapted to spray water onto a portion of the disc during rotation; whereby the powder composition can be tumbled, moistened, and agglomerated into pellets within the rotating drum.

In accordance with another aspect of the invention, the improvements provide a method of preparing animal feed in pellet form, the method comprising: providing a powder composition including powder feed ingredients mixed together, the powder composition being capable of agglomerating into pellets in the presence of water; providing an appropriate amount of water to the powder composition while tumbling the powder composition, thereby causing the powder composition to agglomerate into pellets.

In accordance with another aspect of the invention, the improvements provide an animal feed pellet made from a powder composition, the powder composition consisting substantially of an agglomeration of insoluble particles of animal feed ingredients, a food-grade phosphate salt, and a food-grade hydraulic binder, each pellet having a moisture content of between 5 and 20%, and being fuirther characterized by a porous consistency thereby providing an increased surface exposure during digestion by an animal.

In some more specific embodiments, the food-grade hydraulic binder used is magnesium oxyde, and the food-grade phosphate salt is mono-dicalcium phosphate.

As used in the present specification and in the appended claims, the terms Pellet Durability Index (PDI) and coefficient of variability are defined as follows:

Pellet Durability Index: it is a measure of the durability of pellets. The degradation of the pellet during handling is estimated with a durability tumbling tester. It is the weight of the pellets after shaking divided by the weight before shaking, which is then multiplied by 100. A Borregaard Pellet Durability Tester was used for our tests.

Coefficient of variability: the coefficient of variability (C.V.) is provided as an estimate of the precision of the data with respect to the mean. This coefficient is calculated by dividing the standard deviation by the mean which is then multiplied by 100.

### DESCRIPTION OF THE FIGURES

Further features and advantages of the present invention will become apparent from the following detailed description, taken in combination with the appended drawings, in which:

FIG. 1 is a schematic view of a setup of a process for producing animal feed in pellet form in accordance with one embodiment of the improvements;

FIG. 2 is a front elevation view of a drum of the setup of FIG. 1; and

FIG. 3 is a side elevation view of the drum of FIG. 2.

It will be noted that throughout the appended drawings, like features are identified by like reference numerals.

### DETAILED DESCRIPTION

The starting powder composition can include various feed ingredients and combinations thereof, and the composition of the pellet product obtained from the process can thus be adapted to the choice of a customer. The size of the pellets can also be selected, this will be discussed below.

In an embodiment, the powder composition includes magnesium oxyde and mono-dicalcium phosphate. The magnesium oxyde and mono-dicalcium phosphate are made part of the powder composition, and the powder composition is submitted to moistening during tumbling. The moistening of the powder composition contributes to the snowball agglomerating effect of the free particles into pellets. The moistening also generates an exothermic reaction. The rate at which the water is provided influences the temperature increase due to the exothermic reaction. By limiting this rate, the heat-sensitive ingredients of the powder composition are preserved.

We have found that the snowball effect takes place when both magnesium oxide and mono-dicalcium phosphate are present in the powder composition. We have also found that it is possible to agglomerate many various types of powder feed ingredients with the magnesium oxide and the mono-dicalcium phosphate when they are mixed therewith and tumbled in the presence of moisture. However, we have found that sodium bicarbonate powder, for instance, impeded the snowball effect. We believe this may also be the case for other substantially soluble powders. Further, we have also found that the snowball effect was enhanced when the powder composition consisted of substantially non-soluble powder ingredients in the form of a relatively fine powder composition, of a fineness similar to flour to the touch, and that the use of coarse powders was more difficult to agglomerate into pellets by this process. A typical size of powders to be used with the process ranges between 50 and 100 microns. We also believe the snowball effect is favored by properly mixing the different powder ingredients into a substantially homogeneous powder composition.

In accordance with one embodiment, pellets having improved characteristics are prepared by tumbling the water-moistened powder composition in a drum, in the following manner: the powder composition is provided in the drum, and a predetermined amount of water (preferably between 5 and 8% of the weight of the initial powder composition) is sprayed in an atomized state onto the powder composition at the upgoing face of the drum at the beginning of the rotation process and until the beginning of agglomeration of the powder composition. The exothermic reaction which follows agglomerates the other free particles available and results in increasing the size of the agglomerates, into pellets of a desired size. This is what we refer to as the snowball effect. If pellets of a greater size is desired, the operator can add some powder composition, add water, and further tumble with the drum, and the pellets will further increase in size by agglomerating the free particles of the powder composition in the snowball effect. The size of the pellets is thus easily adjustable.

The ideal amount of water to be used depends on the specific ingredients provided in the powder composition, and which are in a large part selected as a function of the ingredients which are desired in the final pellet product. The specific powder composition will thus be dictated by the ingredients a customer will desire to have in his pellets. As a general rule, however, it can be said that there needs to be a sufficient amount of water used for the agglomeration and the chemical reaction to take place. If not enough water is used, there will remain a quantity of free powder particles in the feed. The minimal amount of water to be used is typically of about 5% by weight of the powder composition, and only rarely lower. At the other extreme, if too much water is used, the pellets tend to be less resistant, too moist, and have a tendency to break down into chunks. If there is too much water, the moisture content can be lowered by evaporation following formation of the pellets, but preferably, this latter step is avoided by selecting the right percentage of water to start with. Typically, the percentage of water sprayed does not exceed 8%. However, higher percentages may be desired in certain applications. For example, a concentration of 11% has been found suitable to agglomerate certain types of powder compositions. The optimal amount of water to be added to a particular powder composition is determined by experimentation with a small batch, and once a satisfying result is achieved, the process is used to produce a larger batch. Be it noted that the exothermic chemical reaction creates heat, and therefore creates evaporation of some of the water. Inversely, the humidity present in the ambient air tends to be somewhat absorbed by the pellets, and also affects the humidity concentration of the final pellets.

The exothermic chemical reaction which follows the application of water takes a certain time (typically of the order of 15 to 30 seconds), and the operator therefore stops the spraying of water before the desired diameter is reached, and the pellets will continue to agglomerate some free particles and continue to grow, without exceeding the desired dimensions. In some embodiments, it is desired to minimize the size of the water droplets into a fine mist. We believe the use of a finer mist enhances the snowball effect. Typically, the use of larger droplets tend to agglomerate the feed into irregular sizes of pellets, and the larger pellets created by a large water drop tend not to dissociate during the process.

As was discussed above, the process can accommodate a wide variety of substances into the final pellets, and the choice thereof is largely motivated by the requirements of the customer. Some general rules as to the ingredients to be included in the powder composition can nevertheless be drawn at this stage. As discussed, one type of binding reaction was achieved using magnesium oxyde and mono-dicalcium phosphate with water. Skilled chemists will understand that alternative materials also provide similar binding reactions with water, and for instance, ingredients used in the formation of concrete may provide similar results. In the making of animal feed, one should make sure that the binding materials used, and the reaction products in the finished pellets, if any, are food-grade, non-toxic, and preferably be nutritive to the animals.

In this latter example, the magnesium oxide acts as a hydraulic binder. It is believed that other types of hydraulic binders can be used, as long as they are food-grade. In an alternate embodiment, one could use calcium oxide instead, which should provide similar agglomeration results. In fact, it is believed that other alkaline earth oxides could be used as well.

The mono-dicalcium phosphate is a mixture of mono-calcium phosphate and dicalcium phosphate. It is used to provide phosphate to the animals, but is also believed to play a role in the agglomeration process. It is believed that other types of food-grade phosphate salts, such as mono-ammonium phosphate, would provide comparable results.

Further, some materials are more favorable to the agglomeration than others. Some mono phosphates, for instance, have been found more conducive to the snowball effect, or agglomeration. Other materials are not favorable, and are preferably avoided or used in lesser percentages, such as bentonite and sodium bicarbonate for example. Still other materials are unfavorable to agglomeration and will be readily avoided by those skilled in the art. This is the case of most oils and fatty substances. Fatty substances, for example, tend to form their own minor agglomerations with powder particles and act as a wall between agglomerating elements. The remaining ingredients which can be agglomerated using the process is vast.

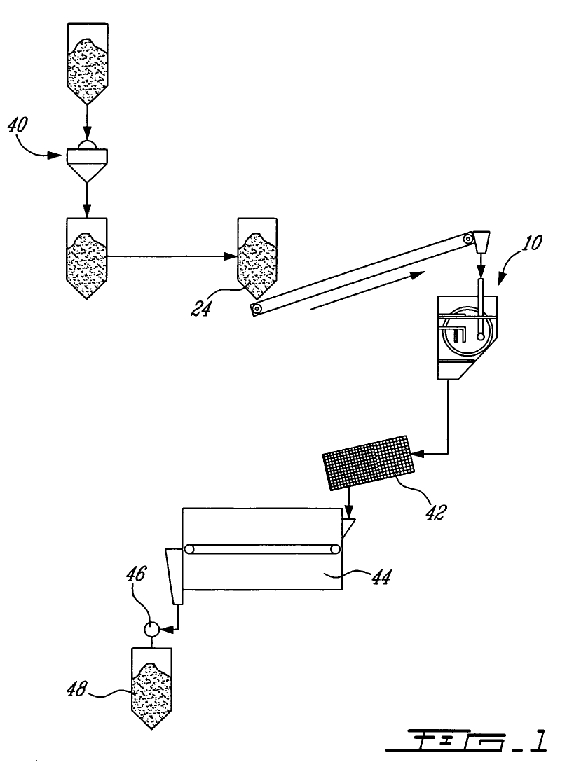

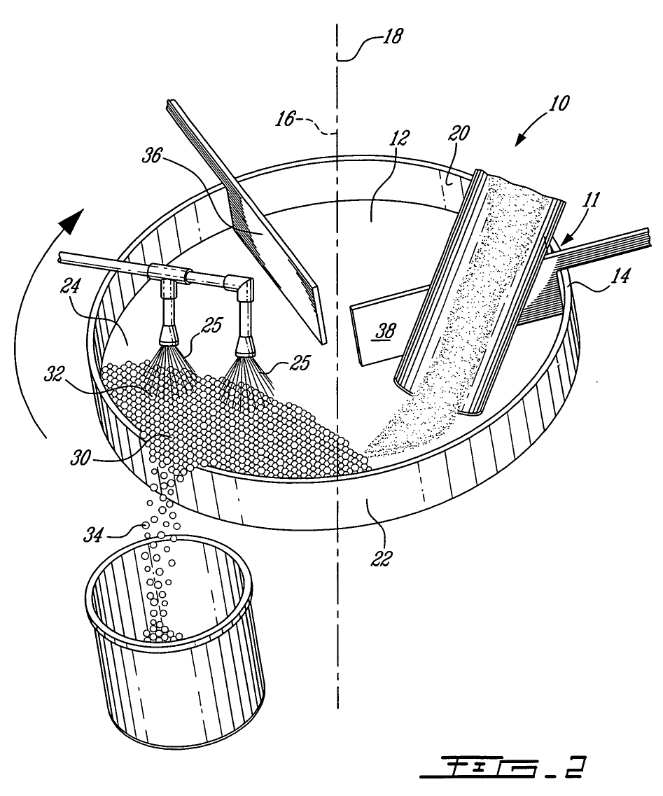

Turning now to FIG. 1, an typical setup for providing a substantially continuous pellet production process is depicted. Typically, a set of ingredients, requested by a customer, are milled into a fine powder in a mill 40. The powder ingredients obtained are then mixed into a substantially homogeneous powder composition which is brought into a tumbler 10. In the tumbler 10, water 25 is regularly added and pellets 34 are produced (see FIG. 2). The pellets 34 fall out of the tumbler 10 are passed through a sieve 42 which eliminates pellets which are of undesired size. In this embodiment, the sieve 42 consists of a cylindrical mesh having two sections corresponding to two mesh sizes, and which rotates about an axis which is slightly off the horizontal. The pellets 34 exiting the sieve 42 can then optionally go through a dryer 44, and flavors or scents can be added 46, before obtaining the final pellet product 48.

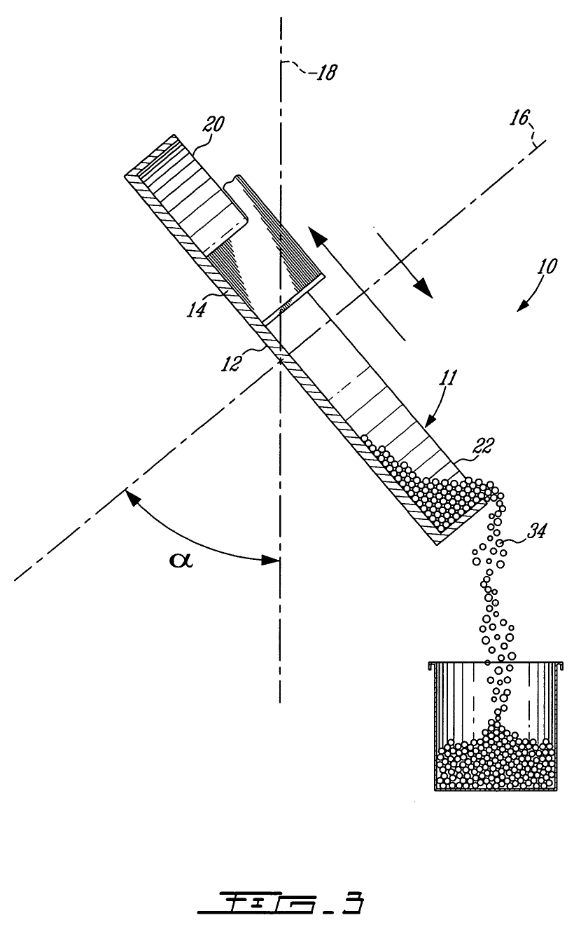

In one embodiment, depicted in FIGS. 2 and 3, the tumbler 10 includes a drum 11 having a large inclined disc 12 and a circumferential wall 14 of a fixed height. The drum 11 rotates about a rotation axis 16 intersecting the plane of the disc 12 at its center. The rotation axis 16 of the drum is inclined with respect to the vertical 18 by a predetermined angle α. Typically, the angle α will be about 75 degrees from the vertical, and can easily vary between 55 and 75 degrees in different applications. The drum 11 rotates about its inclined axis 16, and therefore can be said to have a high zone 20 and a low zone 22 during rotation. Typically, the rotational speed of the drum is between 20 and 120 RPM.

The powder composition 24 in the drum 11, prior to moistening, tends to accumulate in the low zone 22. The rotation of the drum 11 continuously brings the powder composition 24 towards the high zone 20, but the powder composition 22 tends to fall, or roll, back towards the low zone 22 under its own weight due to the inclination of the disc. For agglomeration, water 25 is sprayed, typically in a fine mist by spray nozzles 26, 28, onto the powder composition 24 at the area where the latter is brought towards the high zone 20 by the drum 11, where it tends to agglomerate into pellets 30. The agglomerated pellets 30 roll back atop the upcoming powder composition 24 (being carried by the disc 12) towards the low zone 22. Typically, if the drum rotates in a clockwise direction, and the uppermost point on the high zone 20 can be said to be at twelve O'clock, The spray nozzles 26, 28 will be placed at eight or nine O'clock.

The biggest pellets 30 tend to accumulate at the top, whereas the smaller pellets 32 tend to fall into the interstices between the larger pellets and accumulate underneath. The tumbling pellets 30, 32 maintain a rolling movement during agglomeration, and therefore tend to be at least somewhat spherical. In a preferred application, water 25 and powder composition 24 are regularly added within the drum 11, and the larger pellets 34 regularly fall out the circumferential wall 14 at the low zone 22 of the drum. This becomes a somewhat steady process and in certain types of feed, the machine can be left alone for an hour or so. However, it is often desirable that a skilled technician remain close to the machine and regularly adjusts certain parameters such as disc inclination, rotation speed, flow rate of water through the nozzles, and the like, to keep the pellet production in a substantially optimized state. For a predetermined type of powder composition 24, both the inclination α of the disc rotation axis, the rate at which water is provided to the composition, and the speed at which the drum 11 rotates affect the size of the pellets 34 created, and by adjusting these parameters, the pellet diameter can be controlled.

In many applications, the agglomerating nature of the moistened powder composition 24 results in it sticking to the drum 11. To maintain the tumbler 10 in proper operating conditions, a scraper 36 is used. The scraper 36 is fixed to a non-rotating component, and abuts the rotating disc 12 to remove some adhered powder composition 24. Typically, the scraper 36 is placed around ten O'clock. A second scraper 38 placed, for example, at two O'clock can additionally be used to complete the work of the first scraper 36.

It is thus possible with a single machine to provide a wide range of pellet sizes, as well as a wide variety of pellet compositions. Since the mean size of the pellets can be easily adaptable for each batch of pellets produced, it becomes possible to adapt the size of the pellets to new automatic feed distribution systems which require pellets of specified dimensions.

Other types of tumblers than the one described above can be used to provide the agglomeration process of the pellets. Among other possible alternatives, one prototype we created made use of a hollow cylinder having a closed end and an open end, the hollow cylinder being cantilevered at its closed end and rotatable about a horizontal rotation axis (not illustrated). However, problems related to the control of the pellet uniformity, and time lost stopping the cylinder to retrieve the pellets, has motivated us to discontinue research and development work on this latter prototype in favor of the model proposed, which has been found to provide satisfying results. In the case the proposed model is used, it is desirable that both the rotation speed of the drum and the inclination of the axis of rotation thereof be adjustable to accommodate the many possible types of feed compositions.

The fact that the size of the agglomerations increase in a proportional manner to the surface of contact, it is possible to substantially predict the evolution of the diameter of the pellets during the agglomeration process. By providing the water in the form of a mist with appropriate spray nozzles, it is possible to finely tune and control the amount of water provided and the rate at which it is provided, and thereby control the increase in internal temperature stemming from the exothermal reaction. By limiting the increase in internal temperature, heat-sensitive labile substances such as some vitamins are protected from destruction by heat, and the overall nutrient concentration of the pellets is enhanced.

It will be noted that in the embodiments described above, pellets are produced with no compression other than that of their own weight. The process is thus somewhat delicate, and produces pellets which are relatively porous. We noticed that the absorption of the nutrients by the animals that had eaten pellets produced by the above-described process, was higher than for animals which had eaten pellets that were prepared by processes in which the pellet was compressed. We therefore believe that the porosity of the product obtained by our process enhances its digestibility by the enzymes in the stomach of the animal, compared to compressed pellets, and that the compressed outer surfaces of the compressed pellets may somehow limit or slow the digestion process.

Many known equipments for producing pellets require certain classes of food materials which are adapted to pass through these devices. Typically, manufacturers using such equipments need to adapt the composition of their feed to their equipments. In some applications, the desired food materials are diluted among other materials which facilitate the passing of the composition through the equipments. In some applications, the materials are selected as a function of the minimal volume which is to be produced. For these and other reasons, these methods and processes have notable constraints which have important cost-related consequences.

It will be noted that the improved process, we devised, does not necessitate any dilution of the desired food materials. The resulting pellets thus have relatively concentrated amounts of nutrients. Further, the animal does not need to ingest such a large amount for it to receive the benefits of the prescribed dosage of nutritive elements. The experiments made on animals have shown that a highly satisfying amount of nutrients was absorbed by them when using the improved feed.

Further, since the feed is relatively concentrated in nutrients, it occupies minimal volume and is relatively easy to manipulate during handling, shipping and storage. In this modern day and age, where large farms are abundant, where automated feeding systems are commonly used, and where competent workers are harder and harder to find, we believe this ease of manipulation of an animal feed without compromising its nutritive value to be one great advantage.

Hence, and as it will be seen in the following examples, the feed hereby produced can include many different types of feed ingredients which can be selected by a customer. Some examples of feed ingredients are food materials and food supplements, and can be provided in different combinations thereof. Examples of food materials include cereals such as wheat, corn, oat, rye, canola, barley, mixtures thereof, and/or by-products thereof, as well as salt, for example. Examples of food supplements includes powder substances based on phosphorus, calcium, magnesium, sodium, chlorine, copper, iron, iodine, manganese, selenium or zinc. Other examples of food supplements include vitamins, medicaments, or mixtures thereof, which are substantially preserved throughout the process and are included in the pellets. The exact choice of feed ingredients can therefore be various and is left entirely to one skilled in the art.

The moisture content of the feed is relevant to the agglomeration of the powder composition into pellets. The moisture content is preferably between 5 and 20% by weight of the powder composition used, but it may differ with the types of materials used in the powder composition and the characteristics desired of the final feed. The exact choice thereof in view of specific applications is left entirely to those skilled in the art.

### EXAMPLES

The invention is illustrated but is not limited by the following examples.

### Example 1

One metric ton of a granular feed was prepared by a process as described above. The ingredients include the following:

| Ingredient | Qty (kg) |
|---|---|
| wheat: | 15 kg |
| calcium carbonate: | 55 kg |
| magnesium oxide: | 75 kg |
| mono-dicalcium phosphate: | 487 kg |
| calcium chloride | 233 kg |
| vitamins, medicaments, dyes | 45 kg |
| water | enough to obtain |
| | moisture content |

The granules obtained are substantially spherical, are of generally uniform size between 3 mm and 6 mm, they have a moisture content of 12.5%, they have a PDI of 98.9 and a coefficient of variability of 1.13 for phosphorous, 4.55 for calcium, 1.18 for magnesium and 2.20 for sodium on a dry basis. This feed was given to livestock and was well accepted by all unlike the counter part that is used in powder form.

### Example 2

A granular feed was prepared as in example 1 except that it contained the following:

| Ingredient | Qty (kg) |
|---|---|
| wheat: | 383 kg |
| mono-ammonium phosphate | 173 kg |
| magnesium oxide | 80 kg |
| mono-dicalcium phosphate | 232 kg |
| vitamins, medicaments, dyes | 42 kg |
| water | enough to obtain |
| | moisture content |

The granules obtained are substantially spherical, are of generally uniform size between 3mm and 6mm, they have a moisture content of 11.5%, they have a PDI of 99.9 and a coefficient of variability of 1.08 for phosphorous, 5.12 for calcium, 0.37 for magnesium and 2.93 for sodium on a dry basis. This feed was given to livestock and was well accepted by all unlike the counter part that is used in powder form.

### Example 3

A granular feed was prepared based on the following powder ingredients:

| Ingredient | Qty (kg) |
|---|---|
| monoammonium phosphate | 260.20 |
| manganese oxide 60% | 11.78 |
| magnesium oxide 56% | 135.20 |
| dicalcium phosphate 21/17.5 | 454.08 |
| zinc oxide 77.5% | 9.19 |
| fine salt | 55.70 |
| ferric sulphate 30% | 12.30 |
| dairy premix | 61.55 |

### Example 4

A granular feed was prepared based on the following powder ingredients:

| Ingredient | Qty (kg) |
|---|---|
| fine wheat 13.7% 75 kg/hl | 36.50 |
| limestone −20/+100 | 302.30 |
| manganese oxide 60% | 11.75 |
| magnesium oxide 56% | 134.50 |
| dicalcium phosphate 21/17.5 | 428.62 |
| zinc oxide 77.5% | 9.11 |
| fine salt | 54.40 |
| dairy premix | 22.82 |

### Example 5

A granular feed was prepared based on the following powder ingredients:

| Ingredient | Qty (kg) |
|---|---|
| limestone −20/+100 | 59.30 |
| magnesium oxide 56% | 81.60 |
| dicalcium phosphate 21/17.5 | 536.10 |
| fine salt | 256.00 |
| vitamin and mineral premix | 47.00 |
| dairy premix | 20.00 |

Using the ingredients given in example 5, a feed in granular form was produced with a tumbler 10 of the type hereinabove described. The powder composition was fed to the tumbler 10 at a rate of about 500 Kg/hour. The mixed powders had a size varying typically between 50 and 100 microns. The disc 12 was inclined by about 60 degrees, and rotated at about 30 RPM. The moisture content of the granules ranged between 12 and 16% depending on the ambient humidity.

It is to be noted that the premixes used with the given examples are of the type commonly available in the art and typically contain vitamins, minerals and medicaments.

Although the invention has been described with respect to specific embodiments, it is understood that modifications are possible provided that they fall within the scope of the appended claims.

What is claimed is:

1. A process for pelletizing animal feed comprising:
providing a powder composition on an inclined disc defining an upper and lower zones through which the disc passes during rotation, the powder composition consisting of powders of a food-grade hydraulic binder, a food-grade phosphate salt, and at least one substantially insoluble feed ingredient;
rotating the disc such that the powder composition is carried towards the upper zone;
spraying water onto the powder composition as the disc is rotated so as to cause the powder composition to agglomerate into pellets of animal feed; and
causing some of the powder composition to tumble towards the lower zone by gravity.

2. The process of claim 1 wherein the food-grade hydraulic binder is a food-grade alkaline earth oxide.

3. The process of claim 1 wherein the food-grade phosphate salt is one of mono calcium phosphate, dicalcium phosphate, mono ammonium phosphate, and a mixture thereof.

4. The process of claim 1 wherein the food-grade hydraulic binder is magnesium oxyde, and the food-grade phosphate salt consists of at least one of mono calcium phosphate and dicalcium phosphate.

5. The process of claim 1 wherein water and powder composition are added continuously on the disc and wherein the pellets are obtained continuously from the disc by the pellets tumbling towards the lower zone thereof.

6. The process of claim 5 wherein the pellets obtained from the disc are guided into a sieve to eliminate undersized pellets.

7. The process of claim 1 wherein the water is sprayed in an atomized state and wherein the powder composition consists of fine powders of a size typically below 100 microns.

8. Pellets obtained by a process as claimed in claim 1.

9. An apparatus for producing animal feed in pellet form by agglomeration from a powder composition; the apparatus comprising:
a drum, the drum having a disc and a wall circumferential to the disc, the drum being rotatable around a rotation axis thereof, the rotation axis being normal to the disc and being inclined with respect to a vertical axis, defining an upper zone and a lower zone through which the disc passes during rotation;
at least one spray nozzle adapted to spray water onto a portion of the disc moving from the lower zone towards the upper zone during rotation;
wherein the powder composition is tumbled, moistened, and agglomerated into pellets within the rotating drum.

10. The apparatus of claim 9 wherein the inclination of the disc rotation axis is established so that the powder composition is carried by the disc from the lower zone toward the upper zone, moistened by the water sprayed by the spray nozzle, and tumbled down toward the lower zone by gravity.

11. The apparatus of claim 10 wherein the rotational speed of the drum and the feed rate of water through the spray nozzles are established so as to favor the agglomeration of the powder composition into pellets during tumbling.

12. The apparatus of claim 9 wherein the inclination of the rotation axis of the drum is adjustable.

13. The apparatus of claim 9 wherein the rotational speed of the drum is adjustable.

14. The apparatus of claim 9 further comprising at least one scraper adapted to scrape the surface of the disc during rotation of the drum to scrape powder composition from the disc during rotation.

15. A method of preparing animal feed in pellet form, the method comprising:
providing a powder composition including powder feed ingredients mixed together, the powder composition being capable of agglomerating into pellets;
spraying an appropriate amount of water to the powder composition while tumbling the powder composition, thereby causing the powder composition to agglomerate into pellets.

16. The process of claim 15 wherein the powder composition includes a substantial amount of magnesium oxide and mono-dicalcium phosphate.

17. The process of claim 15 wherein the feed ingredients substantially consist of insoluble powders.

18. The process of claim 15 wherein the water is provided to the powder composition in an atomized state.

19. The process of claim 15 wherein the size of the pellets is increased by adding more powder composition and adding more water to the tumbling pellets, the pellets thus agglomerating free particles of the powder composition added.

20. The process of claim 15 wherein the total amount of water provided corresponds to between 5 and 8% by weight of the total amount of powder composition provided.

21. An animal feed pellet made from a powder composition, the powder composition consisting substantially of an agglomeration of insoluble particles of animal feed ingredients, a food grade phosphate salt, and a food grade hydraulic binder, each pellet having a moisture content of between 5 and 20%, and being further characterized by a porous consistency thereby providing an increased surface exposure during digestion by an animal.

22. The animal feed pellet of claim 21 wherein the food grade food-grade hydraulic binder is a food-grade alkaline earth oxide.

23. The process of claim 21 wherein the food-grade phosphate salt is one of mono calcium phosphate, dicalcium phosphate, mono ammonium phosphate, and a mixture thereof.

24. The process of claim 21 wherein the food-grade hydraulic binder is magnesium oxide, and the food-grade phosphate salt consists of at least one of mono calcium phosphate and dicalcium phosphate.

25. The animal feed pellet of claim 24 wherein the concentration of magnesium oxide is between 7 and 20%, and the concentration of dicalcium phosphate is between 20 and 55%.

26. The animal feed pellet of claim 21 wherein the size of the particles of the powder composition is substantially between 50 and 100 microns.
